(19) United States
(12) Patent Application Publication
(10) Pub. No.: US 2026/0037854 A1
(43) Pub. Date: Feb. 5, 2026

(54) MANAGING INFERENCE MODELS BASED ON A STATISTICAL CHARACTERIZATION OF PREDICTIONS

(71) Applicant: Dell Products L.P., Round Rock, TX (US)

(72) Inventors: OFIR EZRIELEV, Be'er Sheva (IL); HANNA YEHUDA, Acton, MA (US); YONIT LOPATINSKI, Shomria (IL)

(21) Appl. No.: 18/788,559

(22) Filed: Jul. 30, 2024

(51) Int. Cl. G06N 20/00

(52) U.S. Cl. CPC G06N 20/00

(57) ABSTRACT

Methods and systems for managing inference models are disclosed. To manage inference models, a plurality of predictions that each indicate whether a state will occur may be obtained, the plurality of predictions being generated by respective inference models of at least one inference model. The plurality of predictions may be analyzed to obtain a statistical characterization regarding agreement in the plurality of predictions. A determination may be made regarding whether the statistical characterization meets criteria. In a first instance of the determination in which the statistical characterization meets the criteria, an action set may be obtained, the action set being based on an occurrence of the state predicted by the plurality of predictions to occur and usable to update an operating state of the data processing system to hedge against a risk of an undesired outcome from the occurrence of the state.

### FIELD

Embodiments disclosed herein relate generally to managing inference models. More particularly, embodiments disclosed herein relate to systems and methods to manage inference models based on a statistical characterization of predictions.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows in accordance with an embodiment.

FIG. 3 shows a flow diagram illustrating a method of managing inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing inference models. An inference model may be used to generate predictions regarding whether a state will occur in the future. At least a portion of the state may be interpreted as an event (e.g., a sandstorm, wind, a temperature increase). The occurrence of the state may affect the availability of resources used to provide computer-implemented services (e.g., data processing systems, hardware/software components of the data processing systems). Based on the predictions, resources may be distributed and/or otherwise made available so that the computer-implemented services may continue to be provided.

However, the inference model used to generate the predictions may be unreliable and/or may otherwise generate predictions that do not meet needs of a downstream consumer of the predictions (e.g., due to the inference model being trained using an incomplete, biased, and/or limited training dataset).

For example, the inference model may predict an occurrence of an event that corresponds to an availability of a first quantity of the resources at a first point in time. However, the predicted event may not occur at the first point in time and/or may otherwise not occur as predicted. As a result, the resources used to provide the computer-implemented services (e.g., the first quantity of the resources) may be unavailable. Thus, the computer-implemented services to be provided, at least in part, using the resources may be interrupted, delayed, and/or of a reduced quality.

To improve the likelihood that resources will be available to provide the computer-implemented services, a plurality of predictions for the future event may be generated by at least one inference model. The plurality of predictions may be analyzed using statistical methods to obtain a statistical characterization of the plurality of predictions (e.g., a mean, median, mode, standard deviation) usable to assess agreement in the plurality of predictions. The statistical characterization may be compared to criteria, which may include comparing a quantity of the statistical characterization to a requirement indicated by the criteria.

If the statistical characterization meets the criteria, an action set may be obtained to mitigate an impact of an undesired outcome of the occurrence of the predicted event. The action set may be obtained using a template selected from a template repository based on a type of the predicted event. The template may be populated using at least the statistical characterization to generate the action set. By performing the action set, an operating state of a data processing system may be updated, and the data processing system may be used to provide computer-implemented services in the updated operating state.

Thus, embodiments disclosed herein may address, among other technical problems, the technical challenge of hedging against a risk of an undesired outcome from a future state event. To hedge against the risk, an action set may be obtained based on a plurality of predictions generated by at least one inference model. By analyzing the plurality of predictions using statistical methods, the action set may have an increased likelihood of being tailored to the occurrence of the state. In doing so, resources used to provide computer-implemented services may be appropriately made available and/or distributed, which may result in computer-implemented services which are more reliable and of an improved quality.

In an embodiment, a method for managing inference models is disclosed. The method may include: obtaining a plurality of predictions that each indicate whether a state will occur in a future, and the plurality of predictions being generated by at least one inference model of the inference models; analyzing the plurality of predictions to obtain a statistical characterization regarding agreement in the plurality of predictions; making a determination regarding whether the statistical characterization meets criteria; and in a first instance of the determination in which the statistical characterization meets the criteria: obtaining an action set, the action set being based on an occurrence of the state predicted by the plurality of predictions to occur and usable to update an operating state of a data processing system to hedge against a risk of an undesired outcome from the occurrence of the state.

The method may also include: performing the action set to update the operating state of the data processing system to an updated operating state; and providing computer-implemented services using the data processing system in the updated operating state.

Each prediction of the plurality of predictions may be substantially generated using a same input dataset, the input dataset being generated by a plurality of data processing systems.

The statistical characterization may include at least one quantity selected from a group consisting of: a mean; a median; a mode; and a standard deviation.

Making the determination may include: identifying at least one quantity of the statistical characterization; identifying a requirement indicated by the criteria that corresponds to the at least one quantity; and analyzing the at least one quantity using the requirement to obtain at least a partial result indicating whether the statistical characterization meets the criteria.

The criteria may include requirements corresponding to quantities of the statistical characterization.

The requirements may include a first requirement for a median of the plurality of predictions falling within a first range, and a second requirement for a standard deviation of the plurality of predictions falling within a second range.

When the median falls within the first range, then the plurality of predictions may indicate that the state is predicted to occur, and when the standard deviation falls within the second range, then the plurality of predictions may indicate that the occurrence of the state has a level of uncertainty falling within an acceptable range.

Obtaining the action set may include: selecting, from a repository of templates keyed to types of states, a template based on a type of the state that is predicted by the plurality of predictions to occur; and populating the template using, at least in part, a quantity of the statistical characterization.

Populating the template may include dynamically generating the action set based on at least the quantity of the statistical characterization.

The template may be customized, at least in part, based on levels of uncertainty of the occurrence of the state indicated by the statistical characterization.

The template may include sets of prototype actions of the action set that are to be retained or removed during the populating of the template based on the levels of uncertainty.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

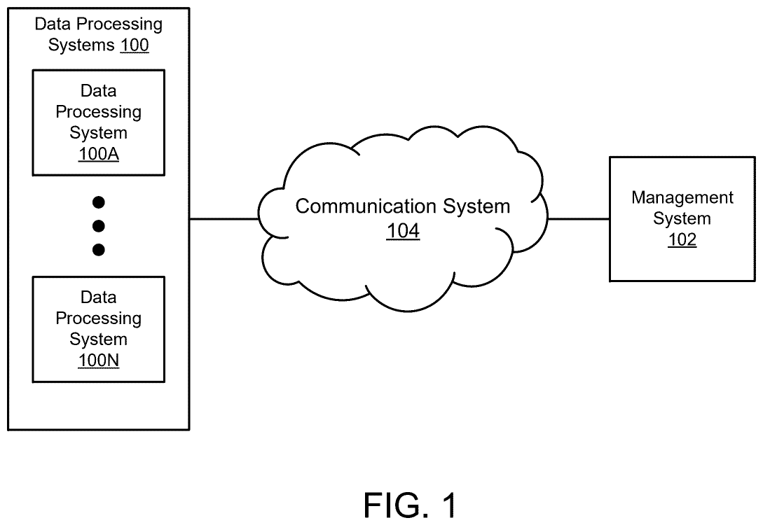

Turning to FIG. 1, a block diagram illustrating a system in accordance with an embodiment is shown. The system shown in FIG. 1 may provide for management of data processing systems that may provide, at least in part, computer-implemented services. The computer-implemented services may include any type and quantity of services including, for example, data services (e.g., data storage, generation, access and/or control services), communication services (e.g., instant messaging services, video-conferencing services), and/or any other type of service that may be implemented with a computing device. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

The system may include any number and/or type of data processing systems 100 (e.g., 100A-100N). Data processing systems 100 may include any number of hardware components (e.g., processors, memory modules, storage devices, communications devices). The hardware components may support execution of any number and type of applications (e.g., software components). Changes in available functionalities of the hardware and/or software components may provide for various types of different computer-implemented services to be provided over time.

To provide the computer-implemented services, a predetermined quantity of hardware and/or software resources may be used. For example, data processing systems 100 may include robotic entities such as unmanned aerial vehicles (e.g., drones) used to provide agriculture management services. To provide the agriculture management services, the drones may be deployed to various portions of a field used to produce crops in order to spray the portions of the field with pesticide. In order to ensure a desired coverage of the field with pesticide, a certain number of drones may be required.

The provision of the computer-implemented services by data processing systems 100 may be managed by, for example, management system 102. Management system 102 may host an inference model used to generate predictions based on input data regarding occurrences of future states which may impact the provision of the computer-implemented services (e.g., performance data of the data processing systems, sensor data collected by the data processing systems, observational weather data collected by doppler radar, radiosondes, weather satellites, buoys, etc.). At least a portion of the states may be interpreted as events (e.g., weather events and/or other events which may impact the operation of data processing systems 100).

Returning to the above example, management system 102 may host an inference model used to generate predictions regarding weather events which may impact the ability of the drones to provide the agriculture management services. For example, the inference model may generate predictions regarding the likelihood that an impending thunderstorm may damage at least a portion of the drones, resulting in undesired outcomes, such as an inability of the drones to spray the pesticide.

However, the inference model used to generate the predictions may be unreliable and/or may otherwise generate predictions that do not meet needs of a downstream consumer of the predictions (e.g., due to the inference model being trained using an incomplete, biased, and/or limited training dataset). Additionally, the predictions may include stochastic elements (e.g., random variance in one or more parameters over time) which result in prediction variability. Prediction variability may reduce a reliability of using the predictions as a basis for making decisions. As a result, the predetermined quantity of hardware and/or software resources may be unavailable to provide the computer-implemented services. For example, the inference model may predict that the thunderstorm is unlikely to affect the ability of the drones to perform the agriculture management services and, therefore, operation of the drones may not be updated. If the prediction is inaccurate (e.g., a portion of the drones are unable to spray pesticide as a result of the thunderstorm), the computer-implemented agriculture management services may be of a reduced quality, interrupted, and/or delayed.

In general, embodiments disclosed herein may provide methods, systems, and/or devices for managing inference models. To manage inference models, a plurality of predictions may be generated by at least one inference model regarding whether a future state will occur. The plurality of predictions may be analyzed in aggregate using statistical techniques to obtain a statistical characterization (e.g., mean, median, mode, standard deviation). The statistical characterization may include quantities which may be compared to requirements included in criteria to determine whether the plurality of predictions indicates that the state will occur.

If the quantities meet the requirements (e.g., the state is predicted to occur), an action set may be generated to hedge against a risk of an undesired outcome from the occurrence of the state. To generate the action set, a template may be selected from a template repository based on a type of state which is predicted to occur. The template may be populated using at least the statistical characterization in order to dynamically generate the action set. The template may also be customized to take into account levels of uncertainty of the occurrence of the state indicated by the statistical characterization.

By doing so, a system in accordance with an embodiment may be used to generate action sets for mitigating (potentially negative) effects of a future state using a plurality of predictions generated by a at least one inference model. The plurality of predictions may be statistically analyzed to determine whether the state is predicted to occur and to obtain a corresponding level of uncertainty. Taking into account statistical characterizations of predictions generated by multiple inference models may increase a likelihood of reliably predicting whether the state will occur, which may result in generating and performing action sets more likely to hedge against undesired outcomes of the state. In doing so, computing resources required to provide computer-implemented services may be made available and/or deployed where needed, which may increase a quality and/or reliability of the provision of the computer-implemented services.

To perform the above-noted functionality, the system of FIG. 1 may include data processing systems 100, and/or management system 102. Data processing systems 100, management system 102, and/or any other type of device not shown in FIG. 1 may perform all, or a portion of, the computer-implemented services independently and/or cooperatively. Each of these components is discussed below.

Data processing systems 100 may include any number and/or type of data processing systems (e.g., 100A-100N), which may include any number of hardware and/or software components configured to provide computer-implemented services. While providing the computer-implemented services, data processing systems 100 may generate data, such as telemetry data, performance data, sensor data, and/or other data related to operation of data processing systems 100. The data generated by data processing systems 100 may be provided to management system 102, which may provide device management services for data processing systems 100.

Management system 102 may include any number and/or type of devices (e.g., other data processing systems, servers, storage devices, user devices) that may be used to provide the device management services. As part of providing the device management services, management system 102 may train and/or host any number and/or type of inference models trained to generate inferences (e.g., predictions). Data provided to management system 102 by data processing systems 100 may include training data usable to train inference models managed by management system 102 and/or input data usable as ingest for inference models managed by management system 102.

To perform its functionality, management system 102 may (i) obtain data (e.g., from data processing systems 100, from other data sources), (ii) process the data (e.g., fill data gaps, transform the data, extract values from the data), (iii) use training data to train any number of inference models, (iv) generate predictions (e.g. using the data as input for the inference models), (v) analyze the predictions (e.g., using statistical methods) to obtain statistical characterizations of the predictions, (vi) compare quantities of the statistical characterizations to requirements included in criteria, (vii) make determinations regarding whether the quantities fulfill the requirements, (viii) if the quantities fulfill the requirements, obtain action sets (e.g., generate the action sets by populating templates), (ix) initiate performance of the action sets by data processing systems 100 (e.g., provide instructions to data processing systems 100 to update an operating state), and/or (x) perform other tasks as part of facilitating the provision of the computer-implemented services.

For example, management system 102 may provide device management services for multiple drones used to provide computer-implemented services outdoors. To provide the device management services for the drones, management system 102 may obtain data from the drones including performance data (e.g., power consumption during operation in various temperatures, time required to complete tasks under various conditions such as poor weather conditions), as well as data from other sources (e.g., observational weather data).

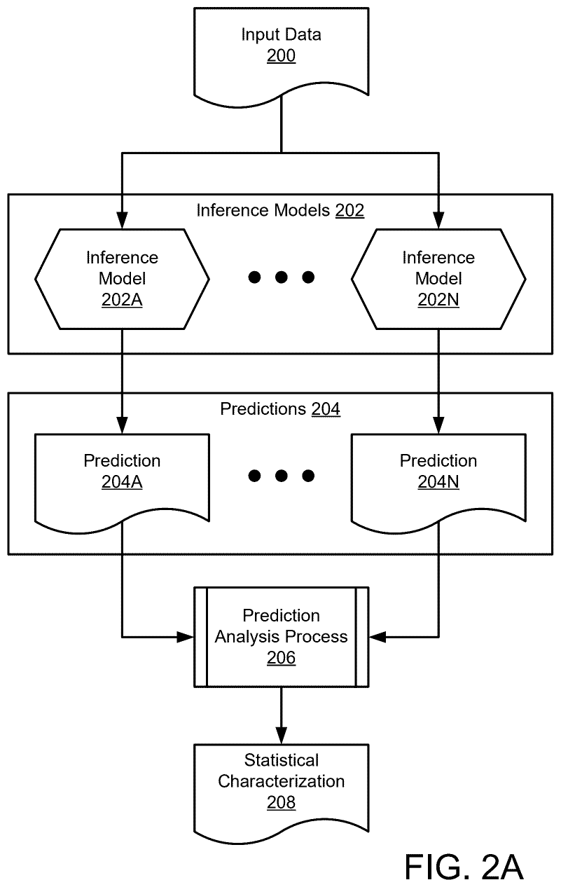

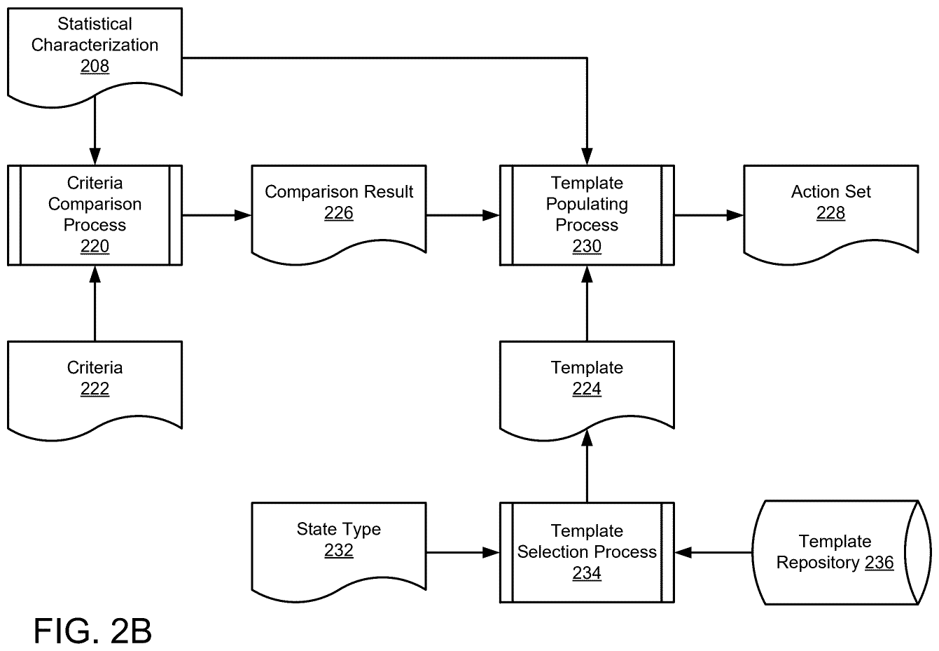

Management system 102 may host inference models trained to generate predictions regarding whether a weather event will result in damage to the drones (e.g., a reduction in the drones' ability to perform agriculture management services as desired). Management system 102 may analyze the predictions to determine whether damage is predicted to occur due to the weather event (e.g., using any number and/or type of statistical methods), and, if damage is predicted, obtain an action set to prevent and/or mitigate the damage (e.g., prevent deployment of the drones to areas affected by the weather event until conditions improve). Refer to the description of FIG. 2A for additional details regarding prediction analysis, and refer to the description of FIG. 2B for additional details regarding obtaining action sets.

Thus, device management services for data processing systems 100 may be provided by management system 102. By doing so, predictions generated by at least one inference model may be analyzed using various statistical techniques to determine whether there is sufficient agreement in the predictions that a state will occur (e.g., by comparing a statistical characterization to criteria). Based on the results of the analysis, an action set may be performed to mitigate the effects of undesired outcomes from the occurrence of the state, which may result in computer-implemented services which have a reduced likelihood of being interrupted and/or delayed.

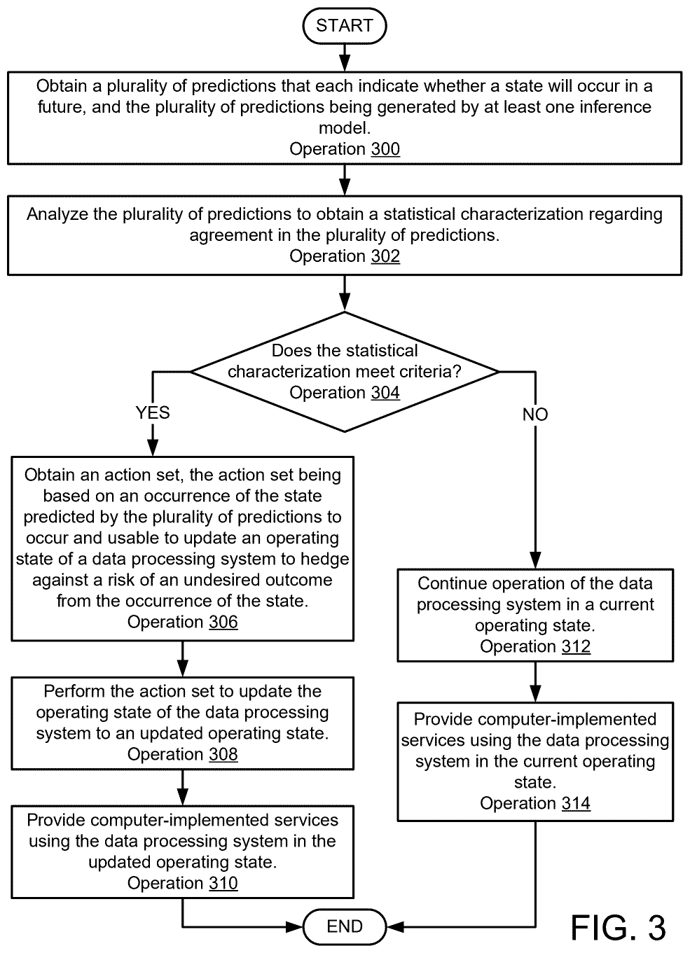

When providing their functionality, any of data processing systems 100, and/or management system 102 may perform all, or a portion, of the processes, interactions, and methods illustrated in FIGS. 2A-3.

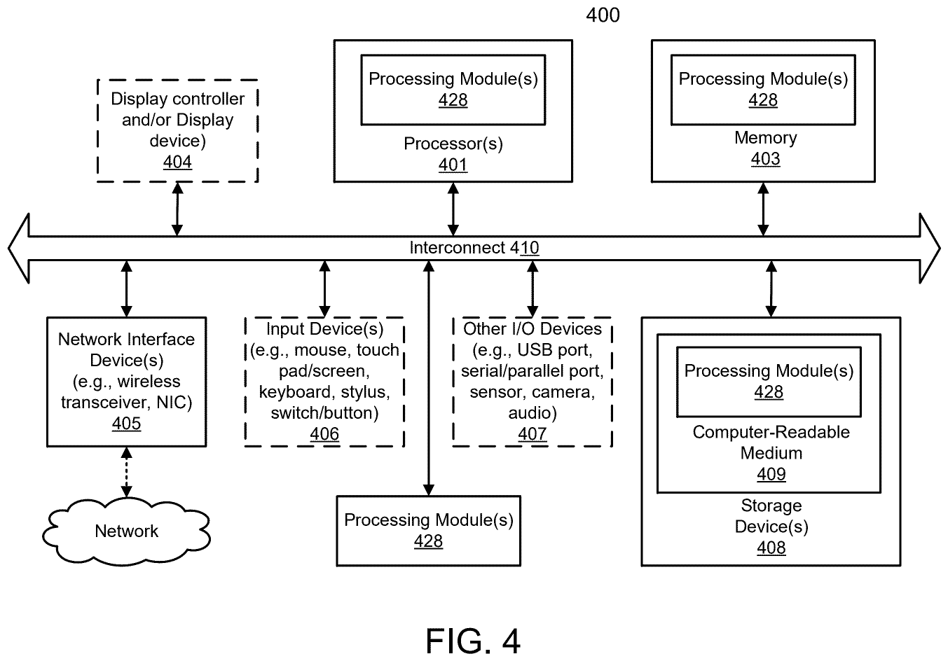

Any of data processing systems 100 and/or management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 104. Communication system 104 may facilitate communications between the components of FIG. 1. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein. For example, while the system of FIG. 1 shows a single management system (e.g., 102), it will be appreciated that the system may include any number of management systems.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 208) is used to represent data structures, a second set of shapes (e.g., 206, 220) is used to represent processes performed using and/or that generate data, a third set of shapes (e.g., 226) is used to represent large scale data structures such as databases, and a fourth set of shapes (e.g., 202A) is used to represent inference models.

Turning to FIG. 2A, a first data flow diagram in accordance with an embodiment is shown. The first data flow diagram may illustrate data used in and data processing performed in obtaining a statistical characterization using a plurality of predictions generated using at least one inference model.

To obtain the statistical characterization, input data 200 may be used as ingest to generate predictions using inference models (e.g., inference models 202). Inference models 202 may be hosted by a management system (e.g., management system 102, not shown) responsible for managing operation of data processing systems used to provide computer-implemented services (e.g., data processing systems 100, not shown). Input data 200 may include any type and/or quantity of data, including data generated by data processing systems 100 (e.g., collected using sensors, telemetry data, performance data) and/or data from any other data source (e.g., databases, other management systems, other data processing systems).

Input data 200 may be provided to inference models 202 and used as ingest to generate predictions. Inference models 202 may include any type (e.g., machine learning, decision tree, quantile regression, deterministic simulation, computationally-driven simulation, dynamic simulation, analytical simulation) and/or quantity of inference models (e.g., 202A-202N). Inference models 202 may be trained using training data which defines goals for predictions made by the inference models. Parameters of the inference models may be selected using an optimization process (e.g., an objective function may be defined in terms of the training data and predictions made by the inference models, and a global optimization method such as gradient descent may be used to identify parameters that most faithfully reproduce the trends in the training data).

Once the parameters of an inference model (e.g., inference model 202A) are set, then the inference model may be used to make predictions. A single inference model (e.g., 202A) may be used to generate predictions and/or a plurality of inference models (e.g., 202A-202N) may be used to generate predictions. Differences in model type, training data, and/or the optimization process may result in variability between the predictions made by the inference models, even when the predictions are generated using the same (and/or substantially the same) input dataset. Additionally, stochastic elements (e.g., random variance in one or more parameters over time) may result in prediction variability (e.g., within a single model and/or simulation) for a given set of conditions.

The input dataset used as ingest for inference models 202 (e.g., input data 200) to generate predictions may be substantially the same for each prediction. For example, substantially the same input data may include criteria which permit up to a 10% difference in the input data (e.g., at least 90% of the input data is the same). In a second example, the criteria may indicate that the input data may only differ by 5% to be considered substantially the same (e.g., at least 95% of the input data is the same). In a third example, the criteria may indicate that the input data may differ by 25% to be considered substantially the same (e.g., at least 75% of the input data is the same).

Input data 200 may be ingested by inference models 202, and predictions 204 may be generated as output. Predictions 204 may include a plurality of predictions (e.g., 204A-204N) generated by respective inference models that each indicate whether a state will occur in a future (e.g., at any future point in time, over a duration of time beginning at any future point in time). For example, predictions 204 may include predictions regarding states which may impact the operation of data processing systems 100, such as changes in temperature, resource availability (e.g., forecasted changes in power supply and/or demand), weather conditions (e.g., rain, hail, wind), and/or any other events which may impact the devices.

For example, data processing systems 100 may include edge devices managed by management system 102, which may include smart streetlights. The smart streetlights may be implemented to conserve power by adjusting the amount of light generated based on data collected by sensors. The data collected by the sensors may include data regarding brightness, humidity, motion, temperature, etc. The data may be provided to management system 102 and used, at least in part, as input data for a plurality of inference model used to generate predictions regarding the occurrence of events which may impact the operation of the smart streetlights.

The plurality of predictions (e.g., predictions 204A-204N) may be used to perform prediction analysis process 206. During prediction analysis process 206, predictions 204 may be analyzed in aggregate to obtain a statistical characterization (e.g., statistical characterization 208) regarding agreement in the plurality of predictions. The statistical characterization may be obtained using any type and/or quantity of statistical methods (e.g., techniques, calculations, data fitting), including averaging, population distribution calculations, hypothesis testing, regression, analysis of variance, and/or any other type of statistical methods. The statistical characterization may include a mean, median, mode, and/or standard deviation for predictions 204.

Continuing with the above example, the at least one inference model may generate predictions based on the sensor data and/or data from other sources regarding an increase in temperature which may affect operation of 100 smart streetlights (e.g., the operation may be impacted to an undesirable degree if the operation continues in the current operating state). For example, temperature data collected by the sensors and temperature data collected from weather satellites may be used as input data for 20 inference models. Of the 20 inference models, 5 may generate predictions indicating the temperature will affect operation of 60 smart streetlights, 10 may generate predictions indicting the temperature will affect operation of 80 smart streetlights, 3 may generate predictions indicating the temperature will affect operation of 75 smart streetlights, and 2 may generate predictions indicting the temperature will affect operation of 10 smart streetlights.

A prediction analysis process may be used to analyze the predictions using statistical methods to obtain statistical characterizations including a median (e.g., 77.5 smart streetlights will be affected) and a standard deviation (e.g., 21.3 smart streetlights).

Thus, by implementing the data flow shown in FIG. 2A, a system in accordance with embodiments disclosed herein may be used to obtain a statistical characterization of a plurality of predictions generated by at least one inference model. The input data used to generate each prediction may be substantially the same, though differences in inference model types, training, and/or optimization may result in variability in the predictions. The variability in the predictions may be analyzed using statistical methods.

Turning to FIG. 2B, a second data flow diagram in accordance with an embodiment is shown. The second data flow diagram may illustrate data used in and data processing performed in generating an action set based on at least a statistical characterization obtained via the analysis of the plurality of predictions shown in FIG. 2A.

To generate the action set (e.g., action set 228), criteria comparison process 220 may be performed. To perform criteria comparison process 220, statistical characterization 208 may be compared to criteria (e.g., criteria 222) in order to make a determination regarding whether statistical characterization 208 meets criteria 222 (e.g., comparison result 226). Making the determination may include (i) identifying at least one quantity of statistical characterization 208, (ii) identifying a requirement indicated by criteria 222 that corresponds to the at least one quantity, (iii) analyzing the at least one quantity using the requirement to obtain at least a partial result indicating whether statistical characterization 208 meets criteria 222, and/or (iv) other methods. The at least one quantity may include a numerical value and/or other types of metrics calculated using a statistical method (e.g., a mean, median, mode, standard deviation) used to quantify a level of agreement between the plurality of predictions.

Criteria 222 may include requirements corresponding to quantities of statistical characterization 208. For example, the requirements may include a first requirement for a median of the plurality of predictions falling within a first range, and a second requirement for a standard deviation of the plurality of predictions falling within a second range. When the median falls within the first range, then the plurality of predictions may indicate that the state is predicted to occur, and when the standard deviation falls within the second range, then the plurality of predictions may indicate that the occurrence of the state has a level of uncertainty falling within an acceptable range (e.g., the state is predicted to occur). In this example, the median and/or the standard deviation falling outside of their respective ranges may indicate that statistical characterization 208 does not meet criteria 222 (e.g., the state is not predicted to occur). Different types of states and/or events, affected devices, and/or other characteristics related to the predictions may result in differences in the requirements included in criteria 222.

Returning to the smart streetlights example, the statistical characterization of the plurality of predictions regarding the number of smart streetlights that may be affected by a future temperature increase may include a median of 77.5 and a standard deviation of 21.3. Criteria for the statistical characterization may include a first range corresponding to the median (e.g., 70-100) and a second range corresponding to the standard deviation (e.g., 0-25). It may be determined that the median and the standard deviation fall within their respective ranges, and thus the statistical characterization may meet the criteria.

If comparison result 226 indicates that statistical characterization 208 meets criteria 222, template populating process 230 may be performed to obtain action set 228. Action set 228 may be based on the occurrence of the state predicted by the plurality of predictions to occur and usable to update an operating state of a data processing system (e.g., predicted to be affected by the state) to hedge against a risk of an undesired outcome from the occurrence of the state. To obtain action set 228, template selection process 234 may be performed. During template selection process 234, a template (e.g., template 224) may be selected from a repository of templates (e.g., template repository 236). Template repository 236 may include any number of templates keyed to different types of states. For example, template 224 may be selected based on a type of the state (e.g., precipitation, temperature increase/decrease, power shortage) that is predicted by the plurality of predictions to occur (e.g., state type 232) and to which template 224 is keyed in template repository 236. State type 232 may be generated as part of the prediction generation process (e.g., may be included in predictions 204 in FIG. 2A, may be appended to statistical characterization 208).

Template 224 may include sets of prototype actions which may be keyed, at least in part, to the quantity of statistical characterization 208. During template populating process 230, template 224 may be populated using the quantity of statistical characterization 208 in order to dynamically generate action set 228. Dynamically generating action set 228 may include selecting actions from the sets of prototype actions included in the populated template.

For example, template 224 may include a schema used to assign levels of impact (e.g., on the data processing systems) of undesired outcomes due to the occurrence of the state. The levels of impact may be keyed to statistical characterizations for the type of state. For example, a first range of median values indicating a number of devices affected by the state may correspond to a first level of impact, and a second range of median values may correspond to a second level of impact, with the second level of impact being higher than the first level of impact. Prototype actions may be selected from template 224 based on the assigned level of impact. Prototype actions may include a list of actions associated with different levels of impact if the state occurred, such as reducing power consumption of data processing systems, powering off data processing systems, moving data processing systems to a different location, etc.

Continuing with the above example, a template may be selected from a repository of templates (e.g., by performing a lookup) based on a type of the predicted event (e.g., a temperature increase). The template may be populated with the median number of smart streetlights predicted to be affected by the temperature increase (e.g., 77.5), and the populated template may indicate a second level of impact if the event occurred (e.g., an increased likelihood of significant damage to the smart streetlights). The second level of impact may be used to generate an action set by retaining actions of the prototype actions which correspond to the second level of impact to hedge against the risk of damage to the smart streetlights. Actions of the prototype actions that do not correspond to the second level of impact may be removed from the action set. The selected actions used to generate the action set may include powering off the smart streetlights to decrease the risk of damage due to operation in high temperatures. While described with respect to retaining and/or removing actions of the prototype actions included in the template, any number of additional actions (e.g., from an action set repository) not included in the template may be added to the action set (e.g., based on input from a subject matter expert).

Template 224 may be customized, at least in part, based on levels of uncertainty of the occurrence of the state indicated by statistical characterization 208 (e.g., the standard deviation of the predictions, other metrics of uncertainty). Customizing template 224 may include retaining or removing prototype actions during the populating of the template based on the levels of uncertainty. For example, populating template 224 with a high uncertainty value (e.g., based on ranges of uncertainty values that are assigned corresponding labels such as “high” or “low”) for the predicted event may result in the removal of a prototype action, such as powering off the data processing systems, from template 224 in order to hedge against the uncertainty that the event will occur.

Continuing with the above example, the standard deviation of the predictions may be calculated to be 21.3 and, therefore, may fall within a range indicated by a requirement of criteria 222. If the standard deviation falls within the range indicated by a requirement of the criteria, the standard deviation may be considered high relative to other statistical metrics (e.g., the mean, the median), and thus may indicate a high level of uncertainty in the predictions (e.g., based on labels associated with ranges of standard deviations indicated by criteria 222). The standard deviation may be used to customize the template based on the high level of uncertainty in the predictions by removing prototype actions from the template used to generate an action set.

For example, based on the median of the plurality of predictions, the template may indicate that the smart streetlights are to be powered off. However, powering off the smart streetlights may also result in undesired outcomes, such as unsafe driving and/or walking conditions due to reduced lighting of roads and sidewalks. To hedge against the high uncertainty that the increase in temperature resulting in damage to the smart streetlights will occur, the prototype action of powering off the smart streetlights may be removed from the template. In doing so, other prototype actions from the template may be selected, and/or alternative actions may be selected from an action set repository (not shown). For example, an alternative action such as decreasing the power consumption of the smart streetlights may be selected, and used to generate an action set.

Once template 224 has been customized using statistical characterization 208, action set 228 may be generated. Generating action set 228 may include selecting actions based on template 224 to update an operating state of a data processing system. Action set 228 may be provided to the data processing system (e.g., via transmission in a message) and performed by updating the operating state of the data processing system to an updated operating state. Computer-implemented services may then be provided using the data processing system in the updated operating state.

Continuing with the above example, an action set for updating operation of the smart streetlights may be generated based on the customized template. The action set may include reducing the power consumption of the smart streetlights by 50%. By performing the action set, there may be a reduced risk of damage to the smart streetlights, while continuing to provide computer-implemented lighting services.

Thus, by implementing the data flow shown in FIG. 2B, a system in accordance with embodiments disclosed herein may increase the likelihood of generating an action set to update an operating state of a data processing system. The updated operating state may reduce an impact of an undesired outcome from the occurrence of a state predicted by at least one inference model.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2B may perform various methods to manage inference models. FIG. 3 illustrates a method that may be performed by the components of the system of FIGS. 1-2B. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing inference models in accordance with an embodiment is shown. The method may be performed, for example, by any of the components of the system of FIG. 1, and/or any other entity without departing from embodiments disclosed herein.

At operation 300, a plurality of predictions may be obtained that each indicate whether a state will occur in a future, and the plurality of predictions may be generated by at least one inference model. Obtaining the plurality of predictions may include (i) obtaining input data, (ii) using the input data as ingest for the at least one inference model (e.g., feeding the input data into the at least one inference model to generate predictions), (iii) obtaining the plurality of predictions as output of the at least one inference model (e.g., generating the predictions by the inference model using the input data), and/or (iv) other methods.

Obtaining the input data may include (i) collecting the input data (e.g., via sensors operably connected to the data processing systems, via generation of the input data by inference models hosted by the data processing systems), (ii) receiving the input data from data processing systems (e.g., via a message, by reading the input data from a storage used by the data processing systems to store data), (iii) receiving the input data from other devices (e.g., via a message), (iv) performing a lookup in a database for data relevant to generating the plurality of predictions, and/or (v) other methods.

Each prediction of the plurality of predictions may be substantially generated using a same input dataset. Substantially generating the plurality of predictions using the same input dataset may include generating the plurality of predictions using input data for at least one inference model which (i) differs by less than 5% (e.g., the input dataset is at least 95% the same), (ii) differs by less than 10% (e.g., the input dataset is at least 90% the same), (iii) differs by less than 25% (e.g., the input dataset is at least 75% the same), and/or (iv) differs by any other amount which is determined by a subject matter expert (and/or based on other criteria) to result in an input dataset that is substantially the same.

At operation 302, the plurality of predictions may be analyzed to obtain a statistical characterization regarding agreement in the plurality of predictions. Analyzing the plurality of predictions may include (i) aggregating the plurality of predictions into a dataset, (ii) using statistical methods to obtain the statistical characterization of the dataset, (iii) providing the dataset to another device and receiving the statistical characterization in response, and/or (iv) other methods.

Using statistical methods may include performing statistical calculations (e.g., averaging, population distribution calculations, hypothesis testing, regression, analysis of variance) to obtain the statistical characterization. The statistical characterization may include a mean, median, mode, standard deviation and/or any other type of statistical characterization of the dataset usable to determine agreement in the plurality of predictions.

At operation 304, a determination may be made regarding whether the statistical characterization meets criteria. Making the determination may include (i) identifying at least one quantity of the statistical characterization (e.g., analyzing the statistical characterization to extract a numerical value and/or other type of metric), (ii) identifying a requirement indicated by the criteria that corresponds to the at least one quantity, (iii) analyzing the at least one quantity using the requirement to obtain at least a partial result indicating whether the statistical characterization meets the criteria, and/or (iv) other methods.

Identifying the requirement indicated by the criteria may include (i) parsing the criteria to identify the requirement corresponding to a type of statistical characterization obtained by analyzing the plurality of predictions, (ii) analyzing the requirement to extract a quantity and/or range of quantities indicated by the requirement, (iii) providing the criteria to another device and receiving the requirement in response, and/or (iv) other methods.

Analyzing the at least one quantity using the requirement may include (i) comparing the quantity of the statistical characterization to the quantity and/or range of quantities indicated by the requirement, (ii) determining whether the quantity of the statistical characterization meets and/or exceeds the quantity indicted by the requirement to obtain at least the partial result, (iii) determining whether the quantity of the statistical characterization falls within the range of quantities indicated by the requirement to obtain at least the partial result, (iv) providing the requirement and the quantity of the statistical characterization to another device and receiving at least the partial result in response, and/or (v) other methods.

If it is determined that the statistical characterization meets criteria, (e.g., the determination is “Yes” at operation 304), then the method may proceed to operation 306.

At operation 306, an action set may be obtained, the action set being based on an occurrence of the state predicted by the plurality of predictions to occur and usable to update an operating state of the data processing system to hedge against a risk of an undesired outcome from the occurrence of the state. Obtaining the action set may include (i) selecting, from a repository of templates keyed to types of states, a template based on a type of the state that is predicted by the plurality of predictions to occur, (ii) populating the template using, at least in part, the quantity of the statistical characterization, and/or (iii) other methods.

Selecting the template may include (i) identifying the type of the state that is predicted to occur (e.g., from a list of types of states based on characteristics of the state), (ii) performing a lookup in the repository of templates to identify the template corresponding to the type of state that is predicted to occur, (iii) providing data regarding the state that is predicted to occur to another device and receiving the template in response, and/or (iv) other methods.

Populating the template may include (i) inputting the quantity of the statistical characterization into the template, (ii) dynamically generating the action set based on at least the quantity of the statistical characterization, and/or (iii) other methods.

Dynamically generating the action set may include (i) obtaining a level of uncertainty of the occurrence of the state indicated by the statistical characterization, (ii) customizing the template, at least in part, based on the level of uncertainty of the occurrence of the state indicated by the statistical characterization, and/or (iii) other methods.

Customizing the template may include (i) obtaining second criteria indicating an acceptable level of uncertainty for performing prototype actions included in the template (e.g., as indicated by a schema included in the template), (ii) retaining prototype actions of the action set if the level of uncertainty meets the second criteria, (iii) removing prototype actions of the action set if the level of uncertainty does not meet the second criteria, (iv) selecting actions from an action set repository based on the customized template, and/or (v) other methods.

At operation 308, the action set may be performed to update the operating state of the data processing system to an updated operating state. Performing the action set may include (i) transmitting instructions to the data processing system (e.g., via a message), the instructions indicating the actions to be performed based on the action set, (ii) parsing the instructions by the data processing system, (iii) executing the instructions by the data processing system to update the operating state to an updated operating state, and/or (iv) other methods.

At operation 310, computer-implemented services may be provided using the data processing system in the updated operating state. Providing the computer-implemented services in the updated operating state may include (i) performing functions of the data processing system in a modified state (e.g., at a reduced power, at a reduced processor frequency), (ii) performing the functions of the data processing system in a different location (e.g., in a location where the state is not predicted to occur), (iii) performing the functions of the data processing system at a different time (e.g., before and/or after the occurrence of the state), and/or (iv) other methods.

The method may end following operation 310.

Returning to operation 304, if it is determined that the statistical characterization does not meet criteria (e.g., the determination is “No” at operation 304), then the method may proceed to operation 312.

At operation 314, the operation of the data processing system may continue in a current operating state. Continuing operation of the data processing system in the current operating state may include (i) determining that the state is not likely to occur based on the plurality of predictions, (ii) not performing the action set to update the operating state of the data processing system based on the plurality of predictions, and/or (iii) other methods.

At operation 314, the computer-implemented services may be provided using the data processing system in the current operating state. Providing the computer-implemented services in the current operating state may include not modifying the performance of the functions of the data processing system.

The method may end following operation 314.

Thus, using the methods illustrated in FIG. 3, embodiments disclosed herein may provide systems and methods usable to manage inference models by statistically analyzing a plurality of predictions generated by the respective inference models regarding whether a state will occur. An action set may be obtained based on the statistical analysis, and the performance of the action set may allow for the provision of computer-implemented services by a data processing system in an updated operating state. The updated operating state may hedge against a risk of undesired outcomes from the predicted state.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing inference models, the method comprising:
obtaining a plurality of predictions that each indicate whether a state will occur in a future, and the plurality of predictions being generated by at least one inference model of the inference models;
analyzing the plurality of predictions to obtain a statistical characterization regarding agreement in the plurality of predictions;
making a determination regarding whether the statistical characterization meets criteria; and
in a first instance of the determination in which the statistical characterization meets the criteria:
obtaining an action set, the action set being based on an occurrence of the state predicted by the plurality of predictions to occur and usable to update an operating state of a data processing system to hedge against a risk of an undesired outcome from the occurrence of the state.

2. The method of claim 1, further comprising:
performing the action set to update the operating state of the data processing system to an updated operating state; and
providing computer-implemented services using the data processing system in the updated operating state.

3. The method of claim 1, wherein each prediction of the plurality of predictions is substantially generated using a same input dataset, the input dataset being generated by a plurality of data processing systems.

4. The method of claim 1, wherein the statistical characterization comprises at least one quantity selected from a group consisting of:
a mean;
a median;
a mode; and
a standard deviation.

5. The method of claim 1, wherein making the determination comprises:
identifying at least one quantity of the statistical characterization;
identifying a requirement indicated by the criteria that corresponds to the at least one quantity; and
analyzing the at least one quantity using the requirement to obtain at least a partial result indicating whether the statistical characterization meets the criteria.

6. The method of claim 5, wherein the criteria comprise requirements corresponding to quantities of the statistical characterization.

7. The method of claim 6, wherein the requirements comprise a first requirement for a median of the plurality of predictions falling within a first range, and a second requirement for a standard deviation of the plurality of predictions falling within a second range.

8. The method of claim 7, wherein when the median falls within the first range, then the plurality of predictions indicates that the state is predicted to occur, and when the standard deviation falls within the second range, then the plurality of predictions indicates that the occurrence of the state has a level of uncertainty falling within an acceptable range.

9. The method of claim 1, wherein obtaining the action set comprises:
selecting, from a repository of templates keyed to types of states, a template based on a type of the state that is predicted by the plurality of predictions to occur; and
populating the template using, at least in part, a quantity of the statistical characterization.

10. The method of claim 9, wherein populating the template comprises dynamically generating the action set based on at least the quantity of the statistical characterization.

11. The method of claim 10, wherein the template is customized, at least in part, based on levels of uncertainty of the occurrence of the state indicated by the statistical characterization.

12. The method of claim 11, wherein the template comprises sets of prototype actions of the action set that are to be retained or removed during the populating of the template based on the levels of uncertainty.

13. A non-transitory machine-readable medium having instructions stored therein, which when executed by a processor, cause the processor to perform operations for managing inference models, the operations comprising:
obtaining a plurality of predictions that each indicate whether a state will occur in a future, and the plurality of predictions being generated by at least one inference model of the inference models;
analyzing the plurality of predictions to obtain a statistical characterization regarding agreement in the plurality of predictions;
making a determination regarding whether the statistical characterization meets criteria; and
in a first instance of the determination in which the statistical characterization meets the criteria:
obtaining an action set, the action set being based on an occurrence of the state predicted by the plurality of predictions to occur and usable to update an operating state of a data processing system to hedge against a risk of an undesired outcome from the occurrence of the state.

14. The non-transitory machine-readable medium of claim 13, further comprising:
performing the action set to update the operating state of the data processing system to an updated operating state; and
providing computer-implemented services using the data processing system in the updated operating state.

15. The non-transitory machine-readable medium of claim 13, wherein each prediction of the plurality of predictions is substantially generated using a same input dataset, the input dataset being generated by a plurality of data processing systems.

16. The non-transitory machine-readable medium of claim 13, wherein the statistical characterization comprises at least one quantity selected from a group consisting of:
a mean;
a median;
a mode; and
a standard deviation.

17. A data processing system, comprising:
a processor; and
a memory coupled to the processor to store instructions, which when executed by the processor, cause the processor to perform operations for managing inference models, the operations comprising:
obtaining a plurality of predictions that each indicate whether a state will occur in a future, and the plurality of predictions being generated by at least one inference model of the inference models;
analyzing the plurality of predictions to obtain a statistical characterization regarding agreement in the plurality of predictions;
making a determination regarding whether the statistical characterization meets criteria; and
in a first instance of the determination in which the statistical characterization meets the criteria:
obtaining an action set, the action set being based on an occurrence of the state predicted by the plurality of predictions to occur and usable to update an operating state of a data processing system to hedge against a risk of an undesired outcome from the occurrence of the state.

18. The data processing system of claim 17, further comprising:
performing the action set to update the operating state of the data processing system to an updated operating state; and
providing computer-implemented services using the data processing system in the updated operating state.

19. The data processing system of claim 17, wherein each prediction of the plurality of predictions is substantially generated using a same input dataset, the input dataset being generated by a plurality of data processing systems.

20. The data processing system of claim 17, wherein the statistical characterization comprises at least one quantity selected from a group consisting of:
a mean;
a median;
a mode; and
a standard deviation.
